(19) United States
(12) Patent Application Publication
(10) Pub. No.: US 2005/0034707 A1
(43) Pub. Date: Feb. 17, 2005

(54) Control valve for fuel injector and method of use

(76) Inventor: Ulrich Augustin, Blythewood, SC (US)

Correspondence Address: McGuireWoods LLP;Tysons Corner, 1750 Tysons Boulevard, Suite 1800, McLean, VA, 22102-4215, US

(21) Appl. No.: 10/638,322

(22) Filed: Aug. 12, 2003

(51) Int. Cl. F02M 1/00

(52) U.S. Cl. 123/446; 123/494; 123/500; 123/458; 123/498; 239/89; 239/90; 239/95

(57) ABSTRACT

A control valve has a control valve body with a bore and a plurality of fluid connections. A spool valve assembly is moveable within the bore between a first position and a second position. The spool valve assembly has a first hydraulic surface and a second opposing hydraulic surface in fluid communication with a first fluid connection and a second fluid connection, respectively, of the plurality of fluid connections. An actuator has a fluid connection between ambient and the second hydraulic surface of the spool valve assembly. When a current is applied to the actuator, the fluid connection is opened to ambient and the hydraulic force acting on the first hydraulic surface is greater than the hydraulic force acting on the second hydraulic surface such that the spool assembly is moveable to the first or open position. When the actuator is closed, the fluid connection to ambient is blocked and the fluid pressure increases against the second hydraulic surface via fluid supplied by the second fluid connection. In this scenario, the hydraulic force acting on the second hydraulic surface is greater than the hydraulic force acting on the first hydraulic surface such that the spool valve assembly is moveable to the second or closed position

### BACKGROUND OF THE INVENTION

1. Field of the Invention

The invention generally relates to a control valve for a fuel injector and, more particularly, to a piezoelectric control valve for a hydraulically actuated fuel injector.

2. Background Description

There are many types of fuel injectors designed to inject fuel into a combustion chamber of an engine. For example, fuel injectors may be mechanically, electrically or hydraulically controlled in order to inject fuel into the combustion chamber of the engine. In the hydraulically actuated systems, a control valve body may be provided with two, three or four way valve systems, each having grooves or orifices which allow fluid communication between working ports, high pressure ports and venting ports of the control valve body of the fuel injector and the inlet area. The working fluid is typically engine oil or other types of suitable hydraulic fluid which is capable of providing a pressure within the fuel injector in order to begin the process of injecting fuel into the combustion chamber.

In current designs, a driver will deliver a current or voltage to an open side of an open coil solenoid. The magnetic force generated in the open coil solenoid will shift a spool into the open position so as to align grooves or orifices (hereinafter referred to as “grooves”) of the control valve body and the spool. The alignment of the grooves permits the working fluid to flow into an intensifier chamber from an inlet portion of the control valve body (via working ports). The high pressure working fluid then acts on an intensifier piston to compress an intensifier spring and hence compress fuel located within a high pressure chamber. As the pressure in the high pressure chamber increases, the fuel pressure will begin to rise above a needle check valve opening pressure. At the prescribed fuel pressure level, the needle check valve will shift against the needle spring and open the injection holes in a nozzle tip. The fuel will then be injected into the combustion chamber of the engine.

However, in such a conventional system, a response time between the injection cycles may be slow thus decreasing the efficiency of the fuel injector. This is mainly due to the slow movement of the control valve spool. More specifically, the slow movement of the control valve spool may result in a slow activation response time to begin the injection cycle. To remedy this inadequacy, additional pressurized working fluid may be needed; however, additional energy from a high pressure oil pump must be expanded in order to provide this additional working fluid. This leads to inefficiency in the operations of the fuel injector, itself. Also, the working fluid at an end of an injection cycle may not be vented at an adequate response rate due to the slow movement of the control valve spool.

The invention is directed to overcoming one or more of the problems as set forth above.

### SUMMARY OF THE INVENTION

In a first aspect of the invention, a control valve for an injector comprises a control valve body having a bore and a plurality of fluid connections and a spool valve assembly moveable within the bore between a first position and a second position. The spool valve assembly has a first hydraulic surface and a second opposing hydraulic surface in fluid communication with a first fluid connection and a second fluid connection, respectively, of the plurality of fluid connections. An actuator has a fluid connection between ambient and the second hydraulic surface of the spool valve assembly.

In another aspect of the invention, a control valve includes a control valve body having an inlet port and a bore and a spool moveable within the bore between a first position and a second position. A first control piston is positioned proximate a first end of the spool and a first control chamber is formed by the first control piston and the spool. A first fluid connection leads from the inlet to the first control chamber. A second control piston is positioned proximate a second end of the spool, and a plate is positioned proximate an end of the second control piston, remote from the spool. A second control chamber is formed between the plate and the end of the second control piston. A second fluid connection leads from the inlet to the second control chamber. A third fluid connection leads from the second control chamber to ambient and an actuator provides an opening and closing mechanism between the third fluid connection and ambient.

In another aspect of the invention, a control valve kit for retrofitting fuel injectors is provided. The kit includes a spool valve assembly, including (i) a valve body having an inlet port and a bore; (ii) a spool moveable within the bore between a first position and a second position; (iii) a first control piston forming a first control chamber between an end of the spool, the first control chamber being in fluid communication with the inlet port; and (iv) a second control piston forming a second control chamber between an end thereof and a plate positioned remote from the spool. The plate includes an inlet throttle providing communication between a fluid connection from the inlet port to the second control chamber and an outlet throttle providing fluid connection to ambient. The kit further includes an actuator assembly comprising, (i) a piezo actuator; (ii) a check disk actuating between an open position to ambient and a closed position, via the piezo actuator; and (iii) a fluid connection provided between the check disk and the outlet throttle.

In still another aspect of the invention, a fuel injector is provided which includes an intensification body including a bore having a plunger and piston assembly biased in a first direction by a first spring and an intensifier chamber for pressurizing fuel. A nozzle assembly in communication with the intensification body is also provided which includes a needle valve system biased by a second spring to block injection ports and a hydraulic surface to raise the needle valve away from the injection ports during an injection event. A control valve assembly in communication with the intensification body is provided which includes a control valve body having a bore and a plurality of fluid connections. A spool valve assembly is moveable within the bore and has a first hydraulic surface and a second opposing hydraulic surface in fluid communication with a first fluid connection and a second fluid connection, respectively. An actuator is in fluid connection between ambient and the second hydraulic surface of the spool valve assembly.

In another aspect, a method of controlling injection events of an injector includes the steps of providing working fluid to a first control chamber; providing working fluid to a second control chamber; releasing the working fluid in the second control chamber to ambient to begin an injection event; and blocking the working fluid to ambient from the second control chamber and allowing a pressure in the second control chamber to exceed a pressure in the first control chamber to end an injection event.

### BRIEF DESCRIPTION OF THE DRAWINGS

FIG. 1 shows an oil activated fuel injector used with a piezoelectric control valve of the invention;

FIG. 2 shows an exploded view of a control valve body of the invention;

FIG. 3 shows an exploded view of a spool valve assembly of the invention;

FIG. 4 shows an exploded view of an actuator assembly of the invention in a closed position;

FIG. 5a shows a graph of an injector control signal versus time implemented by an aspect of the invention;

FIG. 5b shows a graph of piezo current versus time implemented by an aspect of the invention;

FIG. 5c shows a graph of a spool stroke versus time implemented by an aspect of the invention; and

FIG. 5d shows a graph of injection rate versus time implemented by an aspect of the invention.

### DETAILED DESCRIPTION OF EMBODIMENTS OF THE INVENTION

The invention is directed to an oil activated electronically, mechanically or hydraulically controlled fuel injector and more particularly to a control valve used with an oil activated fuel injector. The control valve of the invention is capable of providing a short control valve stroke which, in turn, translates into a fast response time for the outflow of the inlet rail pressure, which may vary from anywhere between 40 bars to upwards and even greater than 320 bars. The oil activated fuel injector of the invention will thus increase efficiency of the injection cycle. The control valve can also be used as a kit to retrofit already existing fuel injectors.

### Control Valve of the Invention

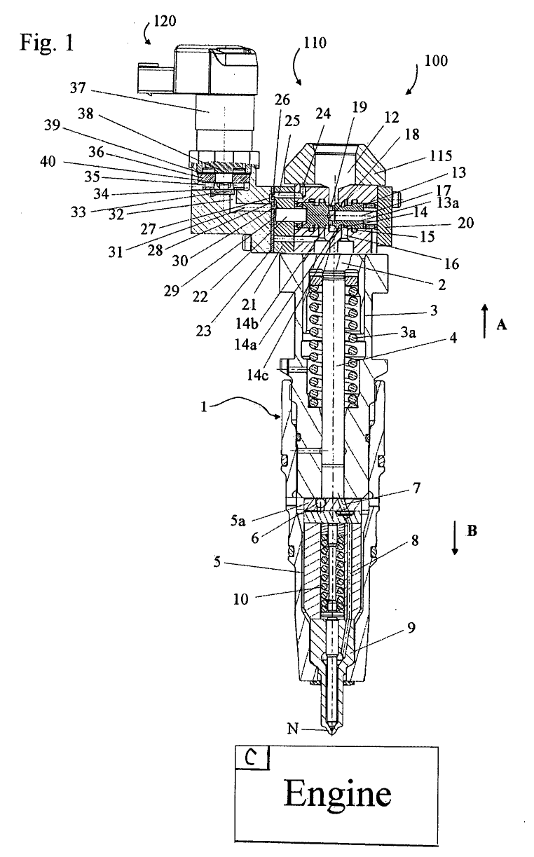

Referring now to FIG. 1, the fuel injector of the invention is generally depicted as reference numeral 100. The fuel injector 100 includes a control valve 110 and an intensifier body 1 having a piston 2 and plunger 4 disposed within a bore chamber 3. A spring 3a biases the piston 2 and the plunger 4 in a direction of arrow “A”. The injector 100 also includes a needle or nozzle assembly 5. A high pressure fuel chamber 7 is disposed between the plunger 4 and the nozzle assembly 5, and is in fluid communication with a fuel line 8 leading to a needle assembly 9. A check valve 6 is also provided within the nozzle assembly 5 or alternatively in a disk plate 5a between the nozzle assembly 5 and the intensifier body 1. A spring 10 biases the needle assembly 9 in a direction of arrow “B”.

Still referring to FIG. 1, a valve body is generally depicted as reference numeral 115 and includes an oil or working fluid inlet 12 and a spool 13. The spool 13 includes grooves having control edges depicted generally as reference numeral 14, i.e., a first leading edge 14a and a second leading edge 14b. The valve body 115 also includes grooves, depicted generally as reference numeral 15, which lead to ambient. Working ports 16 are provided in the valve body 115, which lead to the bore chamber 3 and more specifically are in communication with the piston 2. The working ports 16 are also in fluid communication with the working fluid inlet 12 via the grooves of the spool 13 though a space 14c formed between the leading edge 14a and the working port 16 when the spool 13 is in the open position.

A control piston 17 is provided in a center bore 13a of the spool 13. A control volume chamber 18 is formed between the control piston 17 and the spool 13. A cross bore 19 provides fluid communication between the working fluid inlet 12 and the control volume chamber 18. A stop plate 20 is positioned proximate an end portion of the control piston 17, remote from the spool 13. The stop plate 20 provides a mechanism for limiting movement of the control piston 17 during cycles of the fuel injector 100.

A second control piston 22 is provided on another side of the spool, remote from the control piston 17. In one embodiment, the second control piston 22 has a larger surface area than the control piston 17. In one implantation, the second control piston may be upwards of two times the diameter of the control piston 17. The ration of size may be 1:1.2 upwards of 1:2. in one range, the smaller control piston 17 may be 2.5 mm, but may be 3 mm with the second control piston 22 being 4 mm, in one illustrative implementation. The second control piston 22 is positioned proximate a plate 23 which includes an inlet throttle 26 and an outlet throttle 30.

A fluid connection 24 is provided between the working fluid inlet 12 and the inlet throttle 26, via a fluid connection 25 provided in housing 21. A fluid connection 27 is provided in a piezo stand or housing 41 between the inlet throttle 26 and a bore 28 provided in either the plate 23 or the housing 21. The bore 28 connects to a control volume chamber 29 of the second control piston 22. In one embodiment, the control volume chamber 29 is formed by the second control piston 22, the plate 23 and the housing 21. The outlet throttle 30 is provided in the plate 23 and provides fluid communication between the control volume chamber 29 and a fluid connection 32 to a check plate 33 in an actuator assembly generally depicted as reference numeral 120. The check plate 33 is seated on a check plate seat 34.

As to the actuator assembly 120, a fluid connection 35 is positioned above the check plate 33 and is connected to ambient. A disk 36 having a substantially centrally located bore 36a is positioned between the check plate 33 and a piezo actuator 37. The piezo actuator 37 includes a center pin 38 and an outer part 39. A push rod 40 is in mechanical communication with the center pin 38 and is movable via the piezo actuator 37.

The Actuator assembly includes a housing like a pot, where the piezo stack is located in the center of the pot. The piezo has substantially the same height as the pot and one end of the piezo is welded on the bottom of the pot. In a final manufacturing process the open side of the pot/piezo assembly is grounded. Once the piezo is activated, the stack expands and comes out of the pot. In the application of the invention, the center pin makes a relative stroke to the outer part 39 (border of the pot). Typical strokes of this size of piezo are 20 to 50 microns.

In one embodiment, the piezo actuator includes approximately 200 layers of ceramic discs, which respond to a current applied to the piezo actuator 37. It should be well understood, though, that more or less layers and other types of discs are contemplated by the invention and that the example provided herein is for illustrative purposes.

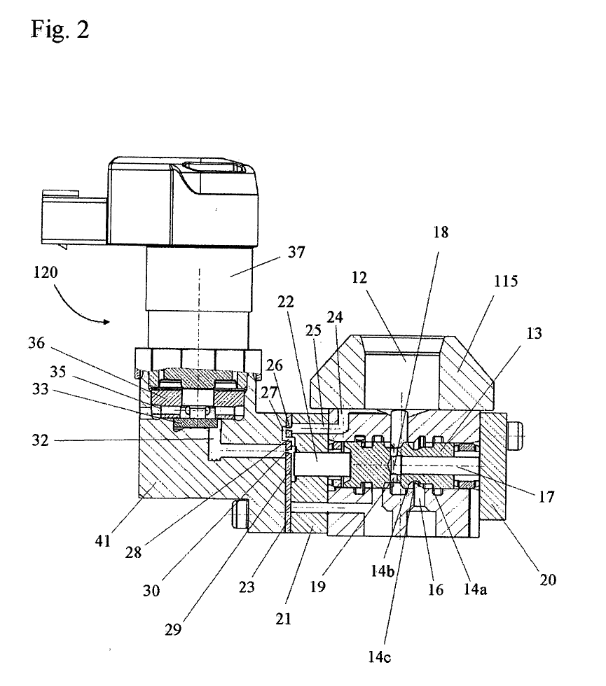

FIG. 2 shows an enlarged view of the assembly of the invention. The assembly basically includes the valve body 115 in addition to the piezo actuator valve assembly 120. The valve body 115 is shown to include the working fluid inlet 12 and the spool 13. The spool 13 includes grooves having a first leading edge 14a and a second leading edge 14b in communication with the working port 16. The space 14c formed between the first leading edge 14a and the working port 16 allows working fluid communication between the working fluid inlet 12 and the working port 16 when the spool 13 is in the open position. In this view, the control piston 17 is biased against the stop plate 20 due to a bigger control volume pressure in the control volume chamber 18 than that provided in the control volume chamber 29. This occurs when the piezo actuator is activated, i.e., a current is applied to the piezo actuator which opens the control volume chamber 29 to ambient. The cross bore 19 provides fluid communication to the control volume chamber 18.

Still referring to FIG. 2, the spool valve assembly 115 includes the second control piston 22 partly moveable within the bore of the housing 21 and proximate to the plate 23. The fluid connection 24, partly in the valve body 115, is provided between the working fluid inlet 12 and the inlet throttle 26, via the fluid connection 25 provided in the housing 21. The bore 28 connects between the control volume chamber 29 and the fluid connection 25 by way of the fluid connection 27 provided in the piezo stand 41. The outlet throttle 30, in the plate 23, provides fluid communication between the control volume chamber 29 and the fluid connection 32 and check plate 33 to ambient via the fluid connection 35. The disk 36 is positioned between the check plate 33 and the piezo actuator 37.

In this configuration, working fluid may pressurize the control volume chamber 29 via the fluid connection 24, the inlet throttle 26, the fluid connections 25 and 27 and the bore 28. In this manner, when the piezo actuator is closed, the pressure will increase in the control volume chamber 29 thus increasing the hydraulic forces acting on the second control piston 22. The hydraulic forces acting on the second control piston 22 will then exceed the hydraulic forces acting on the control piston 17 (due to the larger surface area of the second control piston 22) thus moving the spool valve assembly into the closed position, i.e., the leading edge 14b will overlap the working port 16 and block the space 14c. To open the spool valve assembly, the piezo actuator is opened or activated by applying a current to the driver of the piezo actuator. The fluid pressure within the control volume chamber 29 will be lowered, i.e., the pressure will be released to ambient, by way of the outlet throttle 30, the fluid connection 32, the check plate 33 and the fluid connection 35. In this manner, the pressure in the control volume chamber 29 will be lower than the inlet fluid pressure caused by a steady inflow via the cross bore 19 and working fluid inlet 12. The hydraulic forces acting on the control piston 17 will then exceed the hydraulic forces acting on the second control piston 22 (due to the higher pressure in the control volume chamber 18 than the control volume chamber 29) thus moving the spool valve assembly into the open position, i.e., aligning the space 14c with the working port 16.

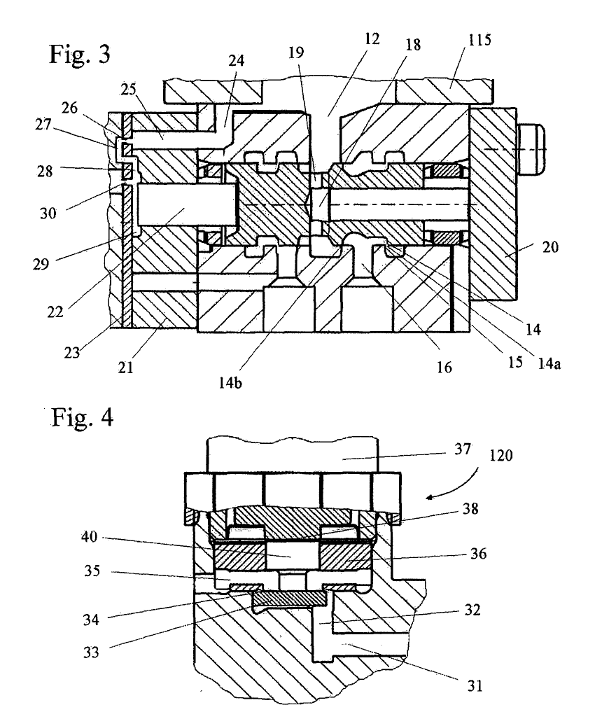

FIG. 3 shows an exploded view of the spool valve assembly in the closed position. The cross bore 19 is provided in the spool 13 and allows fluid communication to remain open between the working fluid inlet 12 and the control volume chamber 18. In this manner, working fluid is constantly provided to the control volume chamber 18. The leading edges 14a and 14b are shown to be in fluid communication or overlapping with the working port 16. In the closed position, the leading edge 14b seals or blocks the fluid communication between the working port 16 and the working fluid inlet 12. The inlet and outlet throttles 26 and 30 are shown to be in communication with the control volume chamber 29. The second control piston 22 is in fluid or hydraulic communication with the working fluid inlet 12 via the fluid connections 24, 25, 27 and inlet throttle 26 and bore 28. As discussed, due to the increased hydraulic forces acting on the second control piston 22, the spool 13 is moved to the closed position and the leading edge 14b seals the space between the working fluid inlet 12 and the working port 16.

FIG. 4 shows an exploded view of the control valve assembly 120 in the closed position. In the closed position, the check plate 33 will block fluid communication between the control volume chamber 29 and ambient. The hydraulic forces acting on the second control piston 28 will be greater than the hydraulic forces acting on the control piston 17 thus moving the spool 13 into the closed position. The stop plate 20 will limit the movement of the control piston 17 and hence the spool 13, in the closed position. The leading edge 14b will block communication between the working fluid inlet 12 and the working port 16.

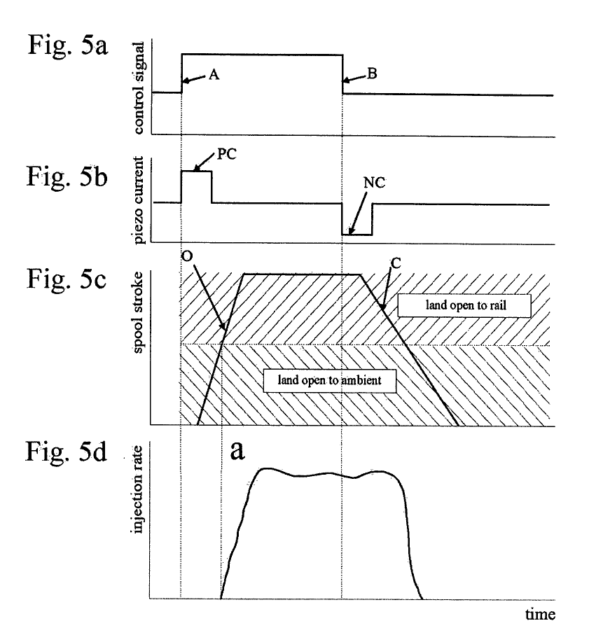

FIGS. 5a-5d show graphs of the injector control signal, the piezo current, the spool stroke and the injection rate versus time, respectively. More specifically, FIG. 5a shows a control signal that is provided to the driver of the piezo actuator 37. The first leading edge “A” of the control signal will trigger the positive driver current “PC” of the piezo actuator, as shown in FIG. 5b. At this time, the piezo actuator 37 will lengthen to open the spool valve assembly, as discussed above. The control signal will be responsible for the duration of the activation of the piezo actuator. In one embodiment, the control signal may last between 200 and 5000 microseconds, depending on the desired fuel quantity. It is also contemplated that the control signal may last for a longer or shorter time period, in certain applications.

Still referring to FIGS. 5a and 5b, the negative driver current “NC” shown in FIG. 5b is triggered by the falling edge “B” of the control signal of FIG. 5a. At this time, the spool valve assembly will begin to close; that is, the spool valve assembly will remain open until a reverse current is applied to the driver of the piezo actuator. In one embodiment, the pulses or currents may be approximately 100 microseconds in duration. It should be understood that a slight delay may exist between the application of the positive driver current “PC” and the negative driver current “NC” and the opening and closing of the spool valve assembly, respectively. This delay, in one embodiment, may be in the order of approximately 100 microseconds or less.

In one embodiment, the positive driver current “PC” of the piezo actuator is +10 amps and the negative driver current “NC” is −10 amps. A corresponding voltage of 150V and 0V may be applied. It should be understood by those of ordinary skill in the art that different amperages may be used depending on the specific application of the invention. For example, more layers used with the piezo actuator may translate into the need for a bigger current and a smaller voltage. Likewise, fewer layers used with the piezo actuator may translate into the need for a smaller current and a bigger voltage. However, in one implementation, a current of +/−10 amps is used with approximately 200 layers of the piezo actuator.

FIGS. 5c and 5d show the relationship between the spool stroke and the injection rate of the fuel injector. Referring to FIG. 5c, the bottom portion of the graph, i.e., land open to ambient, basically represents the spool valve assembly in the closed position; whereas, the upper portion of the graph, i.e., land open to rail, basically represents the spool valve assembly in the open position or a flow connection between the working fluid inlet 12 and the intensifier piston 2. It should be understood by those of ordinary skill in the art, though, that due to delay times, the spool valve assembly may remain open for a short period of time in the bottom portion of the graph after the negative driver current or pulse is applied. Also, the spool valve assembly may remain closed for a short period of time in the top portion of the graph after the positive driver current or pulse is applied.

Now, after the positive driver current “PC” is applied, the spool valve assembly begins to open at a substantially constant speed as represented by the linear line “O”. At the peak of the graph, the spool motion is stopped until the negative driver current “NC” is applied, at which time the spool valve assembly begins to close at a substantially constant speed. FIG. 5d shows the injection rate as it relates to the opening and closing of the spool valve assembly, in one embodiment.

### Method of Use

In operation, the check plate 33 and the spool valve assembly are movable between a closed position and an open position via application of the positive and negative driver current applied to the piezo actuator 37. That is, the current applied to the piezo actuator 37 is used to lengthen and shorten the piezo actuator 37, i.e., ceramic discs of the piezo actuator 37, to open and close the check plate 33 to ambient via the center pin and push rod assembly. In the open position, fluid in the control volume chamber 29 is vented to ambient and the pressure within the control volume chamber 18 is greater than that of the control volume chamber. The hydraulic forces acting on the control piston 17, being greater than the hydraulic forces acting on the second control piston 22, will then move the spool valve assembly to the open position. However, when the negative driver current is applied, the check plate 33 will block ambient and the hydraulic forces acting on the second control piston 22 will increase and become greater than the hydraulic forces acting on the control piston 17 such that the spool valve assembly will be moved into the closed position.

Being more specific, when the piezo actuator 37 is activated or opened, the pressure within the control volume chamber 29 is decreased via the outlet throttle 30, fluid connection 32 and fluid connection 35 to ambient. In this case the hydraulic force acting on the control piston 17 is larger than the hydraulic force acting on the second control piston 22 such that the spool valve assembly is moved to the open position. Once in the open position, the leading edge 14a (creating space 14c) provides a fluid communication between the working fluid inlet 12 and the working port(s) 16. The working fluid then acts on the piston 2 which, in turn, acts on the plunger 4 against the spring force of the spring 3. As the plunger 4 moves towards the high pressure fuel chamber 7, the pressure within the high pressure fuel chamber 7 increases thus forcing the fuel towards the needle assembly 9. The fuel pressure will then overcome the spring force of the needle spring 10 and force the needle into the open position. The fuel will then be injected into a combustion chamber “C” of an engine via nozzles or injection ports “N” of the needle assembly.

When the piezo actuator 37 is closed (negative current applied), the pressure within the control volume or chamber 29 is increased via the fluid connection 24 provided between the working fluid inlet 12 and the inlet throttle 26, via the fluid connection 25. This occurs, partly, due to the check disk blocking ambient. Now, the hydraulic force acting on the second control piston 22 becomes larger than the hydraulic force acting on the control piston 17 such that the spool valve assembly is moved to the closed position. In this case, the leading edge 14b of the spool 13 will block fluid communication between the working port 16 and the working fluid inlet 12. The spring forces of the spring 3 and the spring 10 will overcome the hydraulic forces of the fuel and return the piston and plunger as well as the needle assembly, respectively, to the first or original position. The injection cycle will then end.

While the invention has been described in terms of embodiments, those skilled in the art will recognize that the invention can be practiced with modification within the spirit and scope of the appended claims.

1. A control valve for an injector, comprising:
a control valve body having a bore and a plurality of fluid connections;
a spool valve assembly moveable within the bore between a first position and a second position, the spool valve assembly having a first hydraulic surface and a second opposing hydraulic surface in fluid communication with a first fluid connection and a second fluid connection, respectively, of the plurality of fluid connections; and
an actuator having a fluid connection between ambient and the second hydraulic surface of the spool valve assembly.

2. The control valve of claim 1, wherein the actuator is moveable between an open position and a closed position.

3. The control valve of claim 2, wherein the actuator is moveable to the open position when a current is applied to the actuator.

4. The control valve of claim 3, wherein, in the open position of the actuator, the fluid connection is opened to ambient and a hydraulic force acting on the first hydraulic surface is greater than a hydraulic force acting on the second hydraulic surface such that the spool valve assembly is moveable to the first position.

5. The control valve of claim 2, wherein, in the closed position of the actuator, the fluid connection to ambient is blocked and fluid pressure increases against the second hydraulic surface via fluid supplied by the second fluid connection.

6. The control valve of claim 5, wherein the hydraulic force acting on the second hydraulic surface is greater than the hydraulic force acting on the first hydraulic surface such that the spool valve assembly is moveable to the second position.

7. The control valve of claim 1, wherein the spool valve assembly includes:
a spool;
a first control piston positionable on a first end of the spool and having the first hydraulic surface;
a first control volume chamber formed by the spool and the first hydraulic surface and being supplied with fluid by the first fluid connection;
a second control piston positionable on a second end of the spool and having the second hydraulic surface; and
a second control volume chamber formed between the second hydraulic surface and a plate remote from the second end of the spool, the second control volume chamber being supplied with fluid by the second fluid connection and leading to ambient by the fluid connection.

8. The control valve of claim 1, wherein the actuator includes a check plate which is moveable between an open position and a closed position, the check plate leading to ambient when in the open position and blocks ambient when in the closed position.

9. The control valve of claim 8, wherein the check plate is in fluid communication with the fluid connection and the second hydraulic surface.

10. The control valve of claim 1, wherein the spool valve assembly includes a housing which accommodates a part of the second fluid connection.

11. The control valve of claim 1, wherein the first fluid connection and the second fluid connection are in fluid communication with an inlet working port and the fluid connection is in fluid communication with ambient.

12. The control valve of claim 1, wherein the spool valve assembly includes:
a spool moveable between the first position and the second position;
a first control volume chamber formed between the first hydraulic surface and a portion of the spool;
a second control volume chamber formed between the second hydraulic surface and a plate remote from the spool.

13. The control valve of claim 12, wherein:
the first control chamber is in fluid communication with an inlet via the first fluid connection,
the second control chamber is in fluid communication with the inlet via the second fluid connection, and
the second control chamber is in fluid communication with ambient via the fluid connection.

14. The control valve of claim 13, wherein:
the second fluid connection and the fluid connection are an inlet connection and an outlet connection, respectively,
an inlet throttle is disposed between the second fluid connection and the second control chamber; and
an outlet throttle is disposed between the fluid connection and the second control chamber.

15. The control valve of claim 14, wherein the inlet throttle and the outlet throttle is disposed in the plate.

16. The control valve of claim 1, wherein the first hydraulic surface is formed by a first control piston positioned within a bore of the spool valve assembly.

17. The control valve of claim 1, further comprising a stop plate to limit movement of the first control piston, remote from the second hydraulic surface.

18. The control valve of claim 1, wherein the fluid connection is partly formed by a bore within a plate proximate to the second hydraulic surface.

19. The control valve of claim 1, wherein the actuator includes a check plate, a center pin and a push rod in mechanical communication with the center pin.

20. The control valve of claim 1, wherein the second hydraulic surface is larger than the first hydraulic surface.

21. A control valve, comprising:
a control valve body having an inlet port and a bore;
a spool moveable within the bore between a first position and a second position,
a first control piston positionable proximate a first end of the spool;
a first control chamber formed by the first control piston and the spool;
a first fluid connection leading from the inlet to the first control chamber;
a second control piston positonable proximate a second end of the spool;
a plate positioned proximate an end of the second control piston, remote from the spool;
a second control chamber formed between the plate and the end of the second control piston;
a second fluid connection leading from the inlet to the second control chamber;
a third fluid connection leading from the second control chamber to ambient; and
an actuator providing an opening and closing mechanism between the third fluid connection and ambient.

22. The control valve of claim 21, further comprising a first hydraulic surface associated with the first control chamber and a second hydraulic surface associated with the second control chamber.

23. The control valve of claim 22, wherein the first hydraulic surface is an end of the first control piston and the second hydraulic surface is an end of the second control piston.

24. The control valve of claim 22, wherein the first hydraulic surface is in fluid communication with the first fluid connection and the second hydraulic surface is in fluid communication with the second fluid connection and the third fluid connection.

25. The control valve of claim 22, wherein when the opening and closing mechanism of the actuator is in the open position, the third fluid connection is opened to ambient and a hydraulic force acting on the first hydraulic surface is greater than a hydraulic force acting on the second hydraulic surface such that the spool is moveable to the first position.

26. The control valve of claim 22, wherein when the opening and closing mechanism of the actuator is in the closed position, the third fluid connection to ambient is blocked and fluid pressure increases against the second hydraulic surface via fluid supplied by the second fluid connection.

27. The control valve of claim 26, wherein the hydraulic force acting on the second hydraulic surface is greater than the hydraulic force acting on the first hydraulic surface such that the spool is moveable to the second position.

28. The control valve of claim 22, wherein the opening and closing mechanism of the actuator includes a check plate which is moveable between an open position and a closed position, the check plate leading to ambient when in the open position and blocks ambient when in the closed position.

29. The control valve of claim 28, wherein the check plate is in fluid communication with the third fluid connection and the second hydraulic surface.

30. The control valve of claim 21, wherein the first fluid connection and the second fluid connection are in fluid communication with an inlet working port and the third fluid connection is in fluid communication with ambient.

31. The control valve of claim 21, wherein:
the first control chamber is in fluid communication with an inlet via the first fluid connection,
the second control chamber is in fluid communication with the inlet via the second fluid connection, and
the second control chamber is in fluid communication with ambient via the third fluid connection.

32. The control valve of claim 31, wherein:
the second fluid connection and the third fluid connection are an inlet connection and an outlet connection, respectively;
an inlet throttle is disposed between the second fluid connection and the second control chamber; and
an outlet throttle is disposed between the third fluid connection and the second control chamber.

33. The control valve of claim 32, wherein the inlet throttle and the outlet throttle is disposed in a plate which forms a part of the second control chamber.

34. The control valve of claim 1, further comprising a stop plate to limit movement of the first control piston.

35. A control valve kit for retrofitting fuel injectors, the kit comprising:
a spool valve assembly, including:
a valve body having an inlet port and a bore;
a spool moveable within the bore between a first position and a second position;
a first control piston forming a first control chamber between an end of the spool, the first control chamber being in fluid communication with the inlet port;
a second control piston forming a second control chamber between an end thereof and a plate positioned remote from the spool, the plate including:
an inlet throttle providing communication between a fluid connection from the inlet port to the second control chamber; and
an outlet throttle providing fluid connection to ambient; and
an actuator assembly comprising:
a piezo actuator;
a check disk actuating between an open position to ambient and a closed position, via the piezo actuator; and
a fluid connection provided between the check disk and the outlet throttle.

36. A fuel injector, comprising:
an intensification body including a bore having a plunger and piston assembly biased in a first direction by a first spring and an intensifier chamber for pressurizing fuel;
a nozzle assembly in communication with the intensification body, the nozzle assembly including a needle valve system biased by a second spring to block injection ports and including a hydraulic surface to raise the needle valve away from the injection ports during an injection event; and
a control valve assembly in communication with the intensification body, the control valve assembly including a control valve body having a bore and a plurality of fluid connections, a spool valve assembly moveable within the bore and having a first hydraulic surface and a second opposing hydraulic surface in fluid communication with a first fluid connection and a second fluid connection, respectively, and an actuator in fluid connection between ambient and the second hydraulic surface of the spool valve assembly.

37. The fuel injector of claim 36, further comprising at least one working port extending between the control valve body and the intensification chamber for providing working fluid, during an injection event, to the plunger to overcome a spring force of the first spring and to bias the piston toward the intensifier chamber to pressurize the fuel thus overcoming a spring force of the second spring.

38. The fuel injector of claim 37, wherein fluid is provided through the at least one working port to act on the plunger when a hydraulic force on the second hydraulic surface is greater than a hydraulic force on the first hydraulic surface.

39. The fuel injector of claim 37, wherein fluid is blocked from flowing through the at least one working port when a hydraulic force on the second hydraulic surface is greater than a hydraulic force on the first hydraulic surface and end an injection event.

40. A method of controlling injection events of an injector, the method comprising the steps of:
providing working fluid to a first control chamber;
providing working fluid to a second control chamber;
releasing the working fluid in the second control chamber to ambient to begin an injection event; and
blocking the working fluid to ambient from the second control chamber and allowing a pressure in the second control chamber to exceed a pressure in the first control chamber to end an injection event.

41. The method of claim 40, wherein the releasing step includes energizing an actuator to move a valve to an open position allowing the working fluid to vent to ambient from the second control chamber.

42. The method of claim 40, wherein the blocking step includes deenergizing an actuator to move a valve to block the working fluid to ambient from the second control chamber.
